(19) United States
(12) Patent Application Publication
(10) Pub. No.: US 2016/0172984 A1
(43) Pub. Date: Jun. 16, 2016

(54) ELECTRIC POWER CONVERSION SYSTEM

(71) Applicant: TOYOTA JIDOSHA KABUSHIKI KAISHA, Toyota-shi (JP)

(72) Inventors: Kenichi TAKAGI, Nagakute-shi (JP); Shuntaro INOUE, Nagakute-shi (JP); Takahide SUGIYAMA, Nagakute-shi (JP); Kenichiro NAGASHITA, Toyota-shi (JP); Yoshitaka NIIMI, Susono-shi (JP); Masaki OKAMURA, Toyota-shi (JP)

(73) Assignee: TOYOTA JIDOSHA KABUSHIKI KAISHA, Toyota-shi (JP)

(21) Appl. No.: 14/962,391

(22) Filed: Dec. 8, 2015

(30) Foreign Application Priority Data
Dec. 10, 2014 (JP) 2014-250331

(51) Int. Cl. H02M 3/335

(52) U.S. Cl. CPC H02M 3/33507

(57) ABSTRACT

An electric power conversion circuit and a control circuit are provided. The electric power conversion circuit includes a primary conversion circuit and a secondary conversion circuit. The primary conversion circuit has switching transistors and a primary coil of a transformer. The secondary conversion circuit has switching transistors and a secondary coil of the transformer. Reactors and a connection port are connected between a connection point of the switching transistors and a connection point of the other the switching transistors in the primary conversion circuit.

### INCORPORATION BY REFERENCE

The disclosure of Japanese Patent Application No. 2014-250331 filed on Dec. 10, 2014 including the specification, drawings and abstract is incorporated herein by reference in its entirety.

### BACKGROUND OF THE INVENTION

1. Field of the Invention

The invention relates to an electric power conversion system and, more particularly, to an electric power conversion system including a plurality of input/output ports.

2. Description of Related Art

With development and widespread of electromotive automobiles, such as hybrid vehicles, electric vehicles and fuel-cell vehicles, in-vehicle power supply circuits also tend to become complex and large. For example, a hybrid vehicle includes a drive battery, a system battery, a plug-in external power supply circuit, a DC/DC converter for supplying the drive motor with direct-current power of the drive battery, a DC/AC converter for converting the direct-current power of the drive battery to alternating-current power, a DC/DC converter for supplying an electric power steering (EPS) with the direct-current power of the drive battery, a DC/DC converter for supplying auxiliaries with the direct-current power of the drive battery, and the like, so the configuration of the hybrid vehicle is complex.

Development of a multi-port power supply including a plurality of input/output ports in a single circuit has been proceeding. It is suggested that the size of a power supply circuit is reduced by sharing lines, semiconductor elements, and the like, through multi-port power supply.

Japanese Patent Application Publication No. 2011-193713 (JP 2011-193713 A) describes a configuration that, in an electric power conversion circuit including four ports, electric power is allowed to be converted between a plurality of the selected ports.

FIG. 5 is a circuit configuration view of an electric power conversion circuit according to the related art. The electric power conversion circuit includes a primary conversion circuit and a secondary conversion circuit. The primary conversion circuit includes a full-bridge circuit, a port A (input/output port A) and a port C (input/output port C). The full-bridge circuit includes two magnetic coupling reactors and a chopper circuit. The port A (input/output port A) is provided between the positive electrode bus and negative electrode bus of the full-bridge circuit. The port C (input/output port C) is provided between the negative electrode bus of the full-bridge circuit and a center tap of a primary coil of a transformer. The secondary conversion circuit includes a full-bridge circuit, a port B (input/output port B) and a port D (input/output port D). The full-bridge circuit includes two magnetic coupling reactors and a chopper circuit (right and left arms). The port B (input/output port B) is provided between the positive electrode bus and negative electrode bus of the full-bridge circuit. The port D (input/output port D) is provided between the negative electrode bus of the full-bridge circuit and a center tap of a secondary coil of the transformer.

In a step-up/step-down converter mode, for example, focusing on the port C and port A of the primary conversion circuit, the port C is connected to an upper-to-lower connection point of a left arm via the primary coil of the transformer. Because both ends of the left arm are connected to the port A, a step-up/step-down circuit is connected between the port C and the port A. On the other hand, the port C is connected to an upper-to-lower connection point of a right arm. Because both ends of the right arm are also connected to the port A, another step-up/step-down circuit is connected between the port C and the port A. Thus, the two step-up/step-down circuits are connected between the port C and the port A in parallel with each other. Similarly, for the secondary conversion circuit as well, two step-up/step-down circuits are connected by the right and left arms between the port D and the port B in parallel with each other.

In an insulating converter mode, for example, focusing on the port A of the primary conversion circuit and the port B of the secondary conversion circuit, the primary coil of the transformer is connected to the port A, and the secondary coil of the transformer is connected to the port B. Therefore, by adjusting a phase difference φ in switching interval between the primary conversion circuit and the secondary conversion circuit, it is possible to convert and transfer electric power, input to the port A, to the port B or convert and transfer electric power, input to the port B, to the port A. That is, when the terminal voltage of the primary conversion circuit is advanced in phase with respect to the terminal voltage of the secondary conversion circuit, it is possible to transfer electric power from the primary conversion circuit to the secondary conversion circuit; whereas, when the terminal voltage of the secondary conversion circuit is advanced in phase with respect to the terminal voltage of the primary conversion circuit, it is possible to transfer electric power from the secondary conversion circuit to the primary conversion circuit.

In this way, the electric power conversion circuit according to the related art is able to carry out step-up/step-down operation and transfer of electric power; however, focusing on the primary conversion circuit, voltage output is limited to two ports, that is, the port A and the port C, and, in addition, additional semiconductor elements are required in order to increase direct-current ports. The same applies to the secondary conversion circuit.

### SUMMARY OF THE INVENTION

The invention provides a circuit in which the number of ports of a primary conversion circuit or secondary conversion circuit is increased as compared to the related art without newly adding any semiconductor element.

An aspect of the invention provides an electric power conversion system. The electric power conversion system includes a primary conversion circuit, a secondary conversion circuit and a control circuit. The primary conversion circuit includes a left arm and a right arm between a primary positive electrode bus and a primary negative electrode bus. Each of the left arm and the right arm is composed of two serially connected switching transistors. A primary coil of a transformer is connected between a connection point of the two switching transistors of the left arm and a connection point of the two switching transistors of the right arm. The secondary conversion circuit includes a left arm and a right arm between a secondary positive electrode bus and a secondary negative electrode bus. Each of the left arm and the right arm is composed of two serially connected switching transistors. A secondary coil of the transformer is connected between a connection point of the two switching transistors of the left arm and a connection point of the two switching transistors of the right arm. The control circuit is configured to control switching operations of the switching transistors of the primary conversion circuit and secondary conversion circuit. A reactor and a connection port are connected between the connection point of the two switching transistors of the left arm and the connection point of the two switching transistors of the right arm in the primary conversion circuit or between the connection point of the two switching transistors of the left arm and the connection point of the two switching transistors of the right arm in the secondary conversion circuit.

According to the invention, when the reactor and the connection port are connected between the connection point of the two switching transistors of the left arm and the connection point of the two switching transistors of the right arm in the primary conversion circuit, not only the port connected to the left arm and the port connected to the right arm but also the connection port, that is, three input/output ports in total, are provided, and the three ports are obtained without increasing any semiconductor element. That is, it is possible to supply multiple power supply voltages while suppressing an increase in circuit size. Non-insulated bidirectional electric power conversion is allowed to be carried out among these three ports by adjusting the time ratios of the switching transistors of the primary conversion circuit. In addition, the primary conversion circuit and the secondary conversion circuit are connected by the transformer, and it is possible to transfer electric power in an insulated manner by adjusting the phase difference in switching interval between the primary conversion circuit and the secondary conversion circuit. The same applies to the case where a reactor and a connection port are connected between a connection point of the two switching transistors of the left arm and a connection point of the two switching transistors of the right arm in the secondary conversion circuit.

In the aspect of the invention, an inductance of the reactor may be smaller than a self-inductance of the transformer. According to the invention, because the any one of the coils of the transformer and the reactor are connected in parallel with each other between the connection point of the two switching transistors of the left arm and the connection point of the two switching transistors of the right arm in a corresponding one of the primary conversion circuit and the secondary conversion circuit, it is possible to suppress flow of direct current into the any one of the coils of the transformer by setting the inductance of the reactor to a smaller value than the self-inductance of the transformer.

In the aspect of the invention, a capacitor may be connected in series with one of the transformer in the primary conversion circuit and the transformer in the secondary conversion circuit, to which the reactor and the connection port are not connected. When the capacitor is connected in series with the transformer, it is possible to suppress biased magnetization of the transformer. In the aspect of the invention, a capacitor may be connected in series with one of the primary coil of the transformer in the primary conversion circuit and the secondary coil of the transformer in the secondary conversion circuit, to which the reactor and the connection port are not connected.

According to the aspect of the invention, in the electric power conversion system in which the primary conversion circuit and the secondary conversion circuit are connected to each other via the transformer, any one of the primary conversion circuit and the secondary conversion circuit may include three ports, so it is possible to supply multiple power supply voltages while suppressing an increase in circuit size.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a circuit configuration view of a system according to an embodiment;

FIG. 2 is a view that illustrates control according to the embodiment;

FIG. 3 is a circuit configuration view that shows an input/output configuration example according to the embodiment;

FIG. 4 shows the operation waveform charts of electric power, voltage and phase difference according to the embodiment; and

FIG. 5 is a circuit configuration view according to the related art.

### DETAILED DESCRIPTION OF EMBODIMENTS

Hereinafter, an embodiment of the invention will be described with reference to the accompanying drawings.

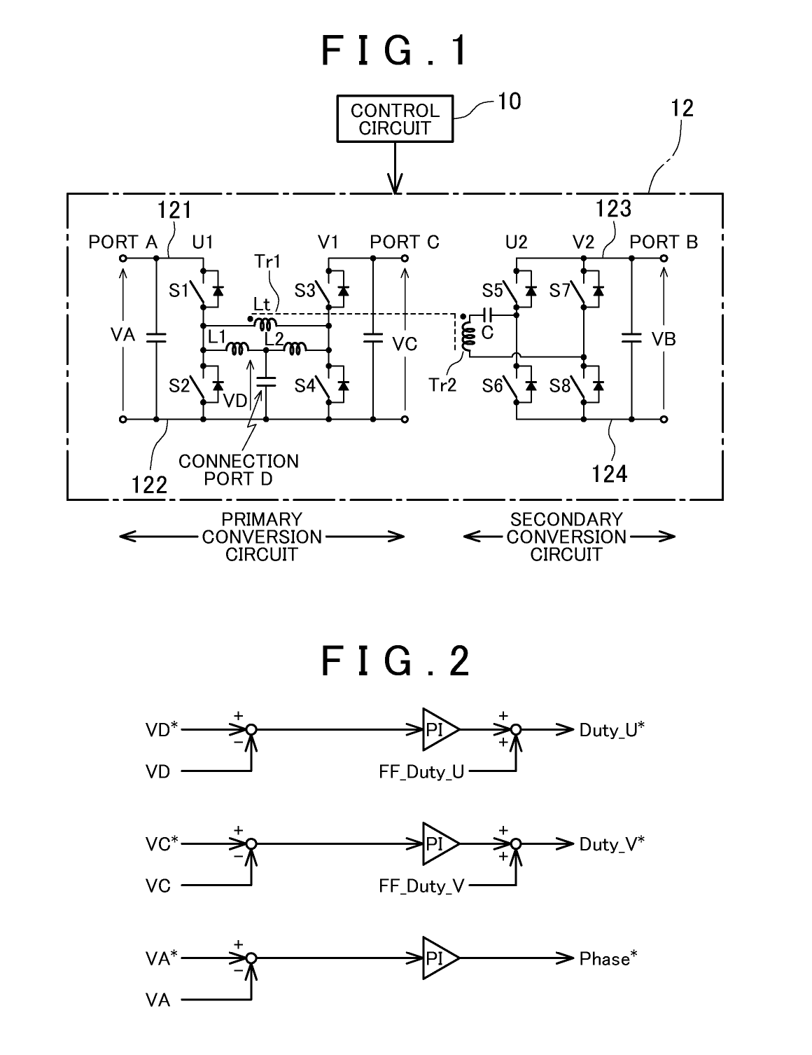

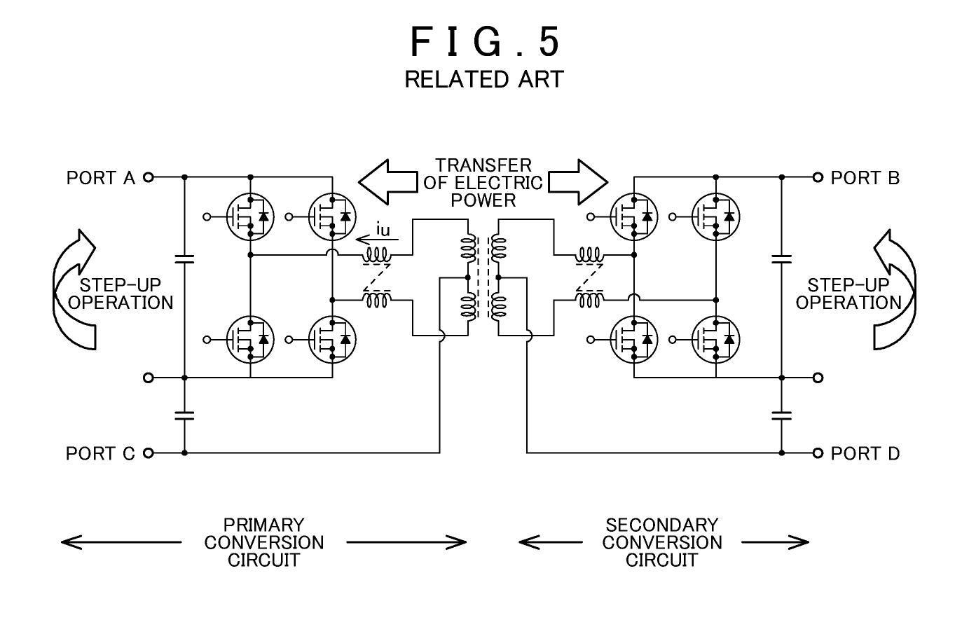

FIG. 1 is a circuit configuration view of an electric power conversion system according to the present embodiment. The electric power conversion system includes a control circuit 10 and an electric power conversion circuit 12. The electric power conversion circuit 12 includes a primary conversion circuit and a secondary conversion circuit. In the electric power conversion system according to the present embodiment, different from the circuit configuration of the related art shown in FIG. 5, the primary conversion circuit or the secondary conversion circuit has a circuit configuration in which bidirectional chopper circuits are connected by a connection port. In the present embodiment, as an example, the circuit configuration in which the bidirectional chopper circuits are connected by the connection port in the primary conversion circuit is shown. That is, the primary conversion circuit includes a port D in addition to a port A and a port C, and the secondary conversion circuit includes a port B.

More specifically, the circuit configuration is as follows. A left arm and a right arm are connected in parallel with each other between a positive electrode bus 121 of the primary conversion circuit and a negative electrode bus 122 of the primary conversion circuit. The left arm is composed of switching transistors S1, S2 connected in series with each other. The right arm is composed of switching transistors S3, S4 connected in series with each other.

The port A (input/output port A) is arranged between the positive electrode bus 121 of the primary conversion circuit and the negative electrode bus 122 of the primary conversion circuit. The input/output voltage of the port A is VA.

The port C (input/output port C) is arranged between the negative electrode bus 122 of the primary conversion circuit and the switching transistor S3 of the right arm. The input/output voltage of the port C is VC.

Serially connected reactors L1, L2 and a primary coil Tr1 of a transformer are connected between a connection point of the switching transistors S1, S2 that constitute the left arm and a connection point of the switching transistors S3, S4 that constitute the right arm. That is, the reactors L1, L2 and the primary coil Tr1 of the transformer are connected to intermediate points of the two bidirectional chopper circuits in parallel with each other.

The connection port D is arranged by connecting a capacitor between the negative electrode bus 122 of the primary conversion circuit and a connection point of the reactors L1, L2. The input/output voltage of the port D is VD.

On the other hand, a left arm and a right arm are connected in parallel with each other between a positive electrode bus 123 and negative electrode bus 124 of the secondary conversion circuit. The left arm is composed of switching transistors S5, S6 connected in series with each other. The right arm is composed of switching transistors S7, S8 connected in series with each other.

The port B (input/output port B) is arranged between the positive electrode bus 123 of the secondary conversion circuit and the negative electrode bus 124 of the secondary conversion circuit. The input/output voltage of the port B is VB.

A secondary coil Tr2 of the transformer is connected between a connection point of the switching transistors S5, S6 that constitute the left arm and a connection point of the switching transistors S7, S8 that constitute the right arm.

The control circuit 10 sets various parameters for controlling the electric power conversion circuit 12, and executes switching control over the switching transistors S1 to S8 of the primary conversion circuit and secondary conversion circuit. The control circuit 10 includes an electric power conversion mode determination processing unit, a phase difference φ determination processing unit, a primary switching processing unit and a secondary switching processing unit as functional blocks. The electric power conversion mode determination processing unit sets a mode in which electric power is converted on the basis of a mode signal from the outside. One mode is a mode in which electric power is converted among the three ports of the primary conversion circuit, and the other mode is an insulated power transfer mode between the primary side and the secondary side. The phase difference φ determination processing unit sets a phase difference φ in the insulated power transfer mode between the primary side and the secondary side. The primary switching processing unit controls switching operations of the switching transistors S1 to S4 of the primary conversion circuit in accordance with the electric power mode and the phase difference φ. The secondary switching processing unit controls switching operations of the switching transistors S5 to S8 of the secondary conversion circuit in accordance with the electric power mode and the phase difference φ.

Insulated power transfer between the primary conversion circuit and the secondary conversion circuit in the present embodiment is controlled by the use of the phase difference φ in the switching interval of the switching transistors between the primary conversion circuit and the secondary conversion circuit as in the case of the related art. For example, when electric power is transferred from the secondary side to the primary side, initially, at the primary side, the switching transistors S1, S4 are turned on, and the switching transistors S2, S3 are turned off. At the secondary side, the switching transistors S5, S8 are turned on, and the switching transistors S6, S7 are turned off. At the secondary side, current flows in order of the switching transistor S5, the secondary coil Tr2 of the transformer and the switching transistor S8, and, at the primary side, current flows in order of the switching transistor S4, the primary coil Tr1 of the transformer and the switching transistor S1.

In the next period, the switching transistors S1, S4, S8 are turned on, and the other switching transistors are turned off. The switching transistor S5 changes from the on state to the off state as compared to the last period; however, when the switching transistor S5 at the secondary side is turned off, current continues to flow via a diode connected in parallel with the switching transistor S6, and the terminal voltage at the secondary side drops to zero. Therefore, the terminal voltage at the secondary side depends on the on or off state of the switching transistor S5.

In the next period, the switching transistors S1, S4, S6, S8 are turned on, and the other switching transistors are turned off.

In the next period, the switching transistors S4, S6, S8 are turned on, and the other switching transistors are turned off. When the switching transistor S1 at the primary side changes from the on state to the off state, current continues to flow via a diode connected in parallel with the switching transistor S1, and the terminal voltage at the primary side does not become zero unless the switching transistor S2 is turned on. Therefore, the terminal voltage at the primary side depends on the on or off state of the switching transistor S2.

A dead time of about several hundreds of nanoseconds to several microseconds may be provided so that the upper and lower switching transistors are not short circuited. That is, a period in which both the switching transistors S1, S2, the switching transistors S3, S4, the switching transistors S5, S6 and the switching transistors S7, S8 are turned off may be provided.

On the other hand, in the related art, step-up/step-down operation between the port A and the port C is allowed to be carried out in the primary conversion circuit by the bidirectional chopper circuits; whereas, in the present embodiment, step-up/step-down operation, that is, non-insulated electric power conversion, is allowed to be carried out among the three ports, that is, the port A, the port B and the port D, in the primary conversion circuit.

FIG. 2 is a schematic view of a control method in the control circuit 10. The phases of the left arm and right arm of the primary conversion circuit are respectively referred to as U1 phase and V1 phase, and the phases of the left arm and right arm of the secondary conversion circuit, corresponding to the phases of the left arm and right arm of the primary conversion circuit, are respectively referred to as U2 phase and V2 phase.

The primary switching processing unit of the control circuit 10 determines a command value Duty_U* of a time ratio (Duty_U) of the U1 phase in feedback control on the basis of a difference between a voltage command value VD* and reference value VD of the port D. In the drawing, the difference between the voltage command value VD* and the reference value VD is subjected to PI control, and then control is stabilized by further adding a feedforward term FFDuty_U; however, PI control and addition of the feedforward term FFDuty_U are not indispensable. Similarly, a command value Duty_V* of a time ratio (Duty_V) of the V1 phase in feedback control is determined on the basis of a difference between a voltage command value VC* and reference value VC of the port C. PI control and addition of a feedforward term are intended to stabilize control, and are not indispensable.

The U2 phase and V2 phase of the secondary conversion circuit desirably have the same waveform shapes as the U1 phase and V1 phase of the primary conversion circuit. This is because, when a voltage waveform that is generated between both terminals in each side of the transformer differs from each other, electric power is transferred even when there is no phase difference between the primary conversion circuit and the secondary conversion circuit. The time ratio of the U2 phase is Duty_U that is the same as the time ratio of the U1 phase. The time ratio of the V2 phase is Duty_V that is the same as the time ratio of the V1 phase. The output voltages of the port A, port C and port D are controlled by adjusting the time ratios of the U1 phase and V1 phase.

When electric power is transferred between the primary conversion circuit and the secondary conversion circuit, the phase difference φ determination processing unit of the control circuit 10 executes control such that electric power is transferred from the primary side to the secondary side by advancing the phase of the primary side with respect to the phase of the secondary side or executes control such that electric power is transferred from the secondary side to the primary side by retarding the phase of the primary side with respect to the phase of the secondary side. The phase difference φ determination processing unit determines a command value Phase* through feedback control on the basis of a difference between an electric power command value VA* and reference value VA of the port A.

Because the U2 phase and V2 phase of the secondary conversion circuit respectively operate at different time ratios, voltage pulses having different widths from each other may be respectively applied to the positive terminal and negative terminal of the secondary coil Tr2 of the transformer. Particularly, when the transformer designed with no gap is used, there is a concern about biased magnetization (a direct-current component is generated in a magnetic flux) of the transformer. Therefore, as shown in FIG. 1, a capacitor C is desirably connected in series with the secondary coil of the transformer.

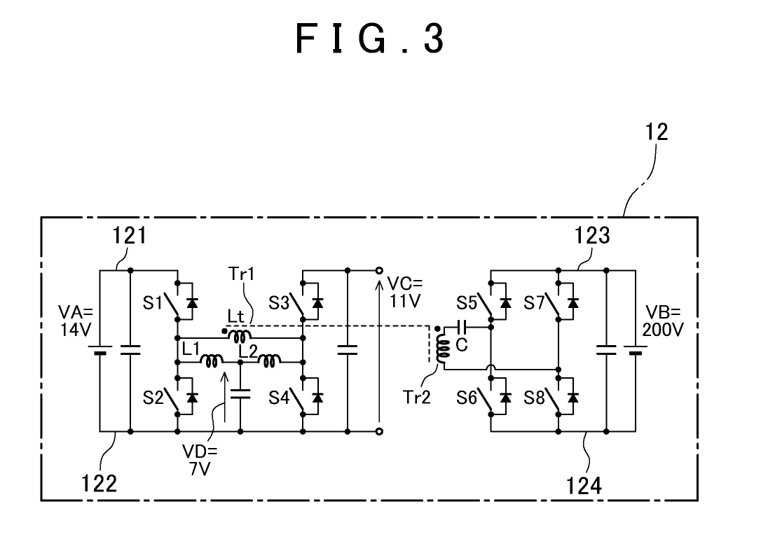

FIG. 3 is an example of the input/output configuration of the electric power conversion system according to the present embodiment. A low-voltage battery, such as a lead storage battery (VA=14 V), is connected to the port A, a high-voltage battery, such as a nickel-metal hydride battery and a lithium ion battery, is connected to the port B (VB=200 V), and 11 V and 7 V are respectively output from the port C and the port D (VC=11 V, VD=7 V). In the related art, only VC=11 V is output from the port C; whereas, in the present embodiment, it is possible to output not only VC=11 V but also VD=7 V without adding any semiconductor element. Therefore, it is possible to output VC=11 V to an in-vehicle certain auxiliary and output VD=7 V to another auxiliary, so it is possible to supply optimal voltages commensurate with auxiliaries.

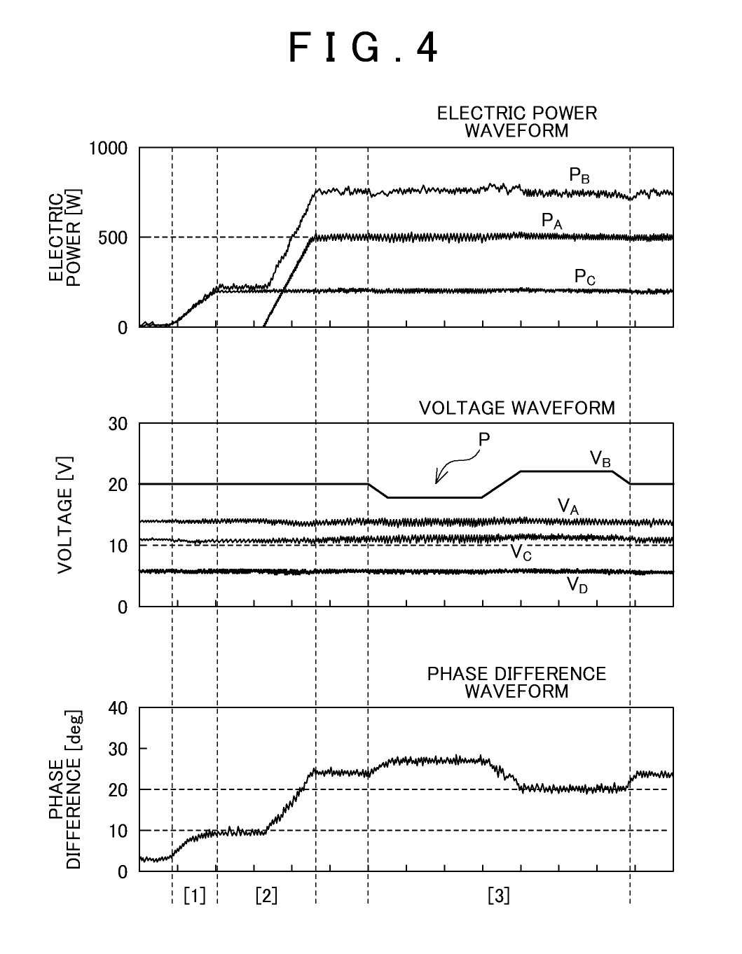

FIG. 4 shows circuit operation waveform charts in the present embodiment. FIG. 4 includes an electric power waveform chart, and PA, PB and PC are respectively electric powers at the port A, port B and port C. FIG. 4 includes a voltage waveform chart, and VA, VB, VC and VD are respectively voltages at the port A, port B, port C and port D. FIG. 4 includes a phase difference waveform chart, and shows a phase difference between the primary conversion circuit and the secondary conversion circuit, which is controlled in accordance with the phase command value Phase* that is calculated by the control circuit 10. The abscissa axis of each chart represents time, and is roughly divided into period [1], period [2] and period [3].

As shown by the electric power waveform chart in FIG. 4, it is assumed that PC increases in the period [1] and PA increases in a stepwise manner in the period [2]. That is, it is assumed that a load at the port C increases in the period [1] and a load at the port A increases in the period [2].

At this time, as shown by the phase difference waveform chart in FIG. 4, the phase difference φ between the primary conversion circuit and the secondary conversion circuit is changed by the control circuit 10, and the phase difference φ increases in the period [1] and the period [2]. In response to the change in the phase difference φ, PB increases in a stepwise manner as shown by the electric power waveform chart in FIG. 4. When the electric power waveform chart of FIG. 4 is compared with the phase difference waveform chart of FIG. 4, it appears that PB changes along the waveform of the phase difference φ. This indicates that a load at the port A and a load at the port C are compensated by an increase in PB resulting from transfer of electric power from the secondary conversion circuit to the primary conversion circuit. As shown by the voltage waveform chart in FIG. 4, the voltage values VA, VC, VD of the port A, port C and port D each are kept constant.

In the period [3], as shown by the voltage waveform chart in FIG. 4, the voltage value VB of the high-voltage battery fluctuates as indicated by P in the chart; however, as shown by the phase difference waveform chart of FIG. 4, the phase difference φ changes in response to fluctuations in the voltage value VB of the port B by the use of the control circuit 10, and the voltage values VA, VC, VD of the port A, port C and port D, which are low-voltage ports, each are kept constant as a result of transfer of electric power from the secondary conversion circuit to the primary conversion circuit. There is known that a high voltage battery, such as a nickel-metal hydride battery and a lithium ion battery, fluctuates in voltage because of various factors. As shown in FIG. 4, the electric power conversion system in the present embodiment has robustness against fluctuations in the voltage of the high-voltage battery and, particularly, is able to keep VC and VD constant, so it is possible to stably supply voltage to in-vehicle auxiliaries.

In this way, in the present embodiment, the circuit configuration based on a bidirectional insulated converter is able to output three direct-current voltages from the primary conversion circuit without increasing any semiconductor element, so it is possible to supply multiple power supply voltages while suppressing an increase in circuit size. Particularly, in the present embodiment, it is possible to control the three direct-current output voltages by adjusting the time ratio of the primary conversion circuit, and it is also possible to control insulated electric power by adjusting the phase difference φ between the primary conversion circuit and the secondary conversion circuit. When the electric power conversion system according to the present embodiment is mounted on a vehicle, it is possible to supply optimal voltages to in-vehicle electronic devices, so it is also possible to reduce an electric power consumption of each electronic device.

In the present embodiment, because the primary coil Tr1 of the transformer and the reactors L1, L2 are connected in parallel with each other between the upper-to-lower connection point of the left arm and the upper-to-lower connection point of the right arm in the primary conversion circuit, there is a possibility that direct current flows into the primary coil Tr1 of the transformer. However, flow of direct current into the primary coil Tr1 of the transformer is suppressed by setting a self-inductance Lt of the transformer to a sufficiently larger value than a total inductance (L1+L2) of the reactors L1, L2, so magnetic saturation of the transformer may be suppressed.

The embodiment of the invention is described above; however, the invention is not limited to this configuration. Various modifications are applicable.

For example, in the present embodiment, the primary conversion circuit includes three ports; instead, the secondary conversion circuit may include three ports. When the secondary conversion circuit includes three ports, a capacitor for preventing biased magnetization of the transformer just needs to be connected in series with the primary coil Tr1 of the transformer.

What is claimed is:

1. An electric power conversion system comprising:
a primary conversion circuit including a left arm and a right arm between a primary positive electrode bus and a primary negative electrode bus, each of the left arm and the right arm being composed of two serially connected switching transistors, and a primary coil of a transformer being connected between a connection point of the two switching transistors of the left arm and a connection point of the two switching transistors of the right arm;
a secondary conversion circuit including a left arm and a right arm between a secondary positive electrode bus and a secondary negative electrode bus, each of the left arm and the right arm being composed of two serially connected switching transistors, a secondary coil of the transformer being connected between a connection point of the two switching transistors of the left arm and a connection point of the two switching transistors of the right arm; and
a control circuit configured to control switching operations of the switching transistors of the primary conversion circuit and secondary conversion circuit, wherein
a reactor and a connection port are connected between the connection point of the two switching transistors of the left arm and the connection point of the two switching transistors of the right arm in the primary conversion circuit or between the connection point of the two switching transistors of the left arm and the connection point of the two switching transistors of the right arm in the secondary conversion circuit.

2. The electric power conversion system according to claim 1, wherein
an inductance of the reactor is smaller than a self-inductance of the transformer.

3. The electric power conversion system according to claim 1, wherein
a capacitor is connected in series with one of the transformer in the primary conversion circuit and the transformer in the secondary conversion circuit, to which the reactor and the connection port are not connected.

4. The electric power conversion system according to claim 1, wherein
a capacitor is connected in series with one of the primary coil of the transformer in the primary conversion circuit and the secondary coil of the transformer in the secondary conversion circuit, to which the reactor and the connection port are not connected.
